(19) United States
(12) Patent Application Publication
(10) Pub. No.: US 2009/0206253 A1
(43) Pub. Date: Aug. 20, 2009

(54) SUBSTRATE INSPECTION METHOD, SUBSTRATE INSPECTION APPARATUS AND STORAGE MEDIUM

(75) Inventors: Misako SAITO, Nirasaki City (JP); Teruyuki Hayashi, Sendai City (JP); Akitake Tamura, Nirasaki City (JP); Kaoru Fujihara, Nirasaki City (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/368,645

(22) Filed: Feb. 10, 2009

(30) Foreign Application Priority Data
Feb. 19, 2008 (JP) 2008-037845

(51) Int. Cl. G01N 23/00

(52) U.S. Cl. 250/307

(57) ABSTRACT

In a substrate inspection method, it is inspected whether the metal electrode is electrically connected to the conductive film by radiating electron beams onto a surface of the substrate to detect the number of secondary electrons emitted therefrom. The method includes placing the substrate onto a mounting table; inspecting the metal electrode by radiating electron beams onto an area of the substrate including the metal electrode at a first acceleration voltage and detecting secondary electrons emitted from the metal electrode; and radiating electron beams onto an area of the substrate not including the metal electrode at a second acceleration voltage. The second acceleration voltage is set such that a difference between the number of electrons entering the insulation film and the number of secondary electrons emitted from the insulation film is smaller at the second acceleration voltage than at the first acceleration voltage.

### FIELD OF THE INVENTION

The present invention relates to a technique for inspecting a substrate in such a way as to radiate electron beams onto the substrate under vacuum conditions and detect the number of secondary electrons emitted from the substrate.

### BACKGROUND OF THE INVENTION

In a process of manufacturing a semiconductor device, a defect inspection for testing electrical characteristics of a metal wiring provided in a substrate, such as a semiconductor wafer (hereinafter, referred to as “wafer”) is conducted in such a way as to bring, for example, a probe needle into contact with the metal wiring exposed from the surface of the substrate and supply an electrical signal from the probe needle to the metal wiring. However, if the size of the metal wiring exposed from the surface of the substrate is 32 nm or less, this method cannot be used to detect a defect of the metal wiring, because it is very difficult to bring the probe needle into contact with the metal wiring.

To inspect a metal wiring, the size of which is 32 nm or less, for example, to inspect a metal wiring of 15 nm, an SEM (scanning electron microscope) inspection method using electron beams is used (see, for example, Japanese Patent Application Publication No. 10-185847). In the SEM test method, an electron gun provided above a substrate radiates electron beams onto the substrate, and a detecting unit detects secondary electrons which are emitted from the substrate by the radiation of the electron beams. Depending on the number of secondary electrons, whether a defect of the substrate is present is determined. Furthermore, a mounting table, onto which the substrate is placed, is moved in a horizontal direction, so that electron beams are sequentially radiated onto the entire surface of the substrate during the inspection process.

An example of a substrate 110 to be inspected by the SEM test method will be explained with reference to FIG. 23A. In the substrate 110, an insulation film 101, which is made of a material, such as silicon oxide, is placed on a surface of a conductive film 110, such as a silicon film. Depressions, for example, contact holes or via holes, are formed in the insulation film 101. Each depression is filled with metal, such as tungsten, thus forming wirings 102 which are electrically connected to the conductive film 100. When electron beams are radiated onto the substrate 110, secondary electrons are emitted from the wirings 102, so that the surfaces of the wirings 102 are positively charged up (electrified). Using such a phenomenon, whether the wirings 102 are electrically connected to the conductive film 100 is inspected.

In detail, as shown in FIG. 23B, when the surfaces of the wirings 102 are positively charged up by the emission of secondary electrons by the radiation of electron beams, in the case of a normal wiring 102 that is electrically connected to the conductive film 100, electrons are rapidly supplied to the wiring 102 from the conductive film 100 by attraction of positive charges, so that the surface of the wiring 102 is neutralized. In the case of a defective wiring 102 that is incorrectly connected to the conductive film 100, when electron beams are radiated onto the wiring 102, the surface of the wiring 102 is positively charged up by emission of secondary electrons, in the same manner as the normal wiring 102. However, because electrons cannot be supplied to the wiring 102 from the conductive film 100, the charge of the surface of the wiring 102 cannot be neutralized. Therefore, some of the secondary electrons emitted from the defective wiring 102 are returned to the defective wiring 102 by attraction of the positive charges. As a result, the number of secondary electrons which are emitted from the defective wiring 102 and reach the detecting unit becomes less than that of the normal wiring 102. Then, a contrast of secondary electrons between the normal wiring 102 and the defective wiring 102 is increased, so that the defective wiring 102 can be easily detected.

However, in the SEM test method, because the mounting table moves such that electron beams are sequentially radiated onto the substrate 110, electron beams are also radiated onto the surface of the insulation film 101. Thus, secondary electrons are also emitted from the insulation film 101, so that the surface of the insulation film 101 is positively charged up. Partially, the effect of the positive charge-up of the insulation film 101 is low, but relatively large charges accumulate in the entire surface of the substrate 110. Therefore, the brightness of a pattern or a contrast may vary by the charge-up of the insulation film 101, or the size of the pattern may become different from the actual size. Due to such influence occurring, the inspection may be incorrectly performed.

### SUMMARY OF THE INVENTION

In view of the above, the present invention provides a technique for restraining charge-up of a substrate in a process of inspecting the substrate in such a way as to radiate electron beams onto the substrate, in which metal electrodes are embedded in an insulation film placed on a conductive film and are electrically connected to the conductive film, and to detect whether the metal electrodes are defective depending on the number of secondary electrons which are emitted from the metal electrodes by the radiation of the electron beams.

In accordance with one aspect of the present invention, there is provided a method for inspecting a substrate by radiating electron beams onto a surface of the substrate including a conductive film and an insulation film that are placed in positional sequence from a bottom to a top and to detect the number of secondary electrons emitted from a surface of a metal electrode embedded in a depression formed in the insulation film so as to inspect whether the metal electrode is electrically connected to the conductive film. The method includes: placing the substrate onto a mounting table; inspecting whether the metal electrode is electrically connected to the conductive film by radiating electron beams onto an area of the substrate including the metal electrode at a first acceleration voltage and detecting secondary electrons emitted from the metal electrode; and radiating electron beams onto an area of the substrate not including the metal electrode at a second acceleration voltage. Herein, the second acceleration voltage is set such that, when the electron beams are radiated onto the insulation film, a difference between the number of electrons entering the insulation film and the number of secondary electrons emitted from the insulation film is smaller at the second acceleration voltage than at the first acceleration voltage.

In the above, a metal other than the metal electrode may be formed in the area of the substrate not including the metal electrode.

Further, the first acceleration voltage and the second acceleration voltage may be converted between each other based on stored data of coordinates on the substrate corresponding to the area including the metal electrode and of coordinates on the substrate corresponding to the area not including the metal electrode.

Preferably, the metal is tungsten.

In accordance with another aspect of the present invention, there is provided a method for inspecting a substrate by radiating electron beams onto a surface of the substrate and detect the number of secondary electrons emitted from the substrate, the substrate having on a surface thereof a patterned area in which a resist mask is formed on an insulation film, and an insulation film area in which the insulation film is exposed outside the resist mask, thus inspecting whether a residue of the resist mask is present on a bottom of a depression formed in the resist mask. The method includes placing the substrate onto a mounting table; inspecting whether the residue is present on the bottom of the depression formed in the resist mask in such a way as to radiate electron beams onto the patterned area at a first acceleration voltage and detect secondary electrons emitted from the bottom of the depression; and radiating electron beams onto the insulation film area at a second acceleration voltage. Herein, the second acceleration voltage is set such that, when the electron beams are radiated onto the insulation film, a difference between the number of electrons entering the insulation film and the number of secondary electrons emitted from the insulation film is smaller at the second acceleration voltage than at the first acceleration voltage.

In the above, the first acceleration voltage and the second acceleration voltage may be converted between each other based on stored data of coordinates on the substrate corresponding to the patterned area and of coordinates on the substrate corresponding to the insulation film area.

The second acceleration voltage may be set such that, when the electron beams are radiated onto the insulation film, a ratio of the number of secondary electrons emitted from the insulation film to the number of electrons entering the insulation film ranges from 0.8 to 1.2.

Further, the stored data may be determined based on pattern information of the substrate. A position at which the electron beams are radiated may be controlled by moving the mounting table, and the stored data may include information for converting the coordinates on the substrate into coordinates of the mounting table.

In the above, the coordinates on the substrate may include coordinates on an X-Y coordinate system corresponding to longitudinal and transverse arrangement of integrated circuit chips on the substrate, and the method further comprises: imaging an alignment mark on the substrate placed on the mounting table, calculating X-Y coordinate axes based on a result of the imaging of the alignment mark, and determining X-Y coordinate axes of a drive system of the mounting table to be parallel to the respective X-Y coordinate axes calculated based on the result of the imaging of the alignment mark.

In accordance with another aspect of the present invention, there is provided an apparatus for inspecting a substrate in such a way as to radiate electron beams onto a surface of the substrate including a conductive film and an insulation film that are placed in positional sequence from a bottom to a top and to detect the number of secondary electrons emitted from a surface of a metal electrode embedded in a depression formed in the insulation film so as to inspect whether the metal electrode is electrically connected to the conductive film. The apparatus includes: a vacuum container for inspection, having therein a mounting table onto which the substrate is placed; an emission unit for radiating electron beams onto the substrate; a detection unit for detecting secondary electrons emitted from the substrate; an actuator for moving the mounting table in a horizontal direction; a storage unit for storing information about an acceleration voltage of the electron beams depending on a position of the mounting table with respect to the horizontal direction; and a control unit for reading the information from the storage unit and output a control signal of the acceleration voltage for radiating the electron beams. Herein, the information of the storage unit is set such that the electron beams are radiated onto an area of the substrate including the metal electrodes at a first acceleration voltage and radiated onto an area of the substrate not including the metal electrodes at a second acceleration voltage. Further, the second acceleration voltage is set such that, when the electron beams are radiated onto the insulation film, a difference between the number of electrons entering the insulation film and the number of secondary electrons emitted from the insulation film is smaller at the second acceleration voltage than at the first acceleration voltage.

In accordance with yet another aspect of the present invention, there is provided an apparatus for inspecting a substrate in such a way as to radiate electron beams onto a surface of the substrate and detect the number of secondary electrons emitted from the substrate, the substrate having on a surface thereof a patterned area in which a resist mask is formed on an insulation film, and an insulation film area in which the insulation film is exposed outside the resist mask, thus inspecting whether a residue of the resist mask is present on a bottom of a depression formed in the resist mask. The apparatus includes: a vacuum container for inspection, having therein a mounting table onto which the substrate is placed; an emission unit for radiating electron beams onto the substrate; a detection unit for detecting secondary electrons emitted from the substrate; an actuator for moving the mounting table in a horizontal direction; a storage unit for storing information about an acceleration voltage of the electron beams depending on a position of the mounting table with respect to the horizontal direction; and a control unit for reading the information from the storage unit and output a control signal of the acceleration voltage for radiating the electron beams. Herein, the information of the storage unit is set such that the electron beams are radiated onto the patterned area at a first acceleration voltage and radiated onto the insulation film area at a second acceleration voltage. Further, the second acceleration voltage is set such that, when the electron beams are radiated onto the insulation film, a difference between the number of electrons entering the insulation film and the number of secondary electrons emitted from the insulation film is smaller at the second acceleration voltage than at the first acceleration voltage.

In the above, the second acceleration voltage may be set such that, when the electron beams are radiated onto the insulation film, a ratio of the number of secondary electrons emitted from the insulation film to the number of electrons entering the insulation film ranges from 0.8 to 1.2.

Further, the information of the storage unit may be determined based on pattern information of the substrate.

In the above, the apparatus may further include: an image capturing unit for imaging an alignment mark on the substrate placed on the mounting table, wherein coordinates on the substrate comprise coordinates on an X-Y coordinate system corresponding to longitudinal and transverse arrangement of integrated circuit chips on the substrate, and wherein the control unit calculates X-Y coordinate axes based on the image of the alignment mark imaged by the image capturing unit before the electron beams are radiated onto the substrate, and outputs a control signal such that X-Y coordinate axes of a drive system of the mounting table are determined to be parallel to the respective X-Y coordinate axes calculated based on the image of the alignment mark.

In accordance with still another aspect of the present invention, there is provided a storage medium that stores a program to be operated in a computer, the program having steps programmed to perform the method of the above.

According to the present invention, electron beams are radiated onto a surface of a substrate including a conductive film and an insulation film which are placed in positional sequence from the bottom to the top and to detect the number of secondary electrons emitted from surfaces of metal electrodes embedded in the depressions formed in the insulation film, so that whether the metal electrodes are electrically connected to the conductive film is inspected. In this inspection, electron beams are radiated on an area including the metal electrodes at a first acceleration voltage, which is the inspection acceleration voltage. Electron beams are radiated onto an area including no metal electrodes at a second acceleration voltage at which a difference between the number of electrons which enter the insulation film and the number of secondary electrons emitted from the insulation film is smaller than at the first acceleration voltage. Therefore, in the area including the metal electrodes, a defective electrode can be easily detected. In the area including no metal electrode, charge-up of the insulation film can be restrained, so that charge-up of the entire substrate is reduced. Furthermore, in an area between the metal electrodes and the insulation film, variation in contrast or brightness and deviation of dimensions can be prevented.

### BRIEF DESCRIPTION OF THE DRAWINGS

The above features of the present invention will become apparent from the following description of embodiments, given in conjunction with the accompanying drawings, in which:

FIGS. 1A and 1B illustrate an example of a substrate used in a method for inspecting the substrate, according to the present invention;

FIG. 2 is a graph illustrating characteristics of acceleration voltages of electron beams radiated onto an insulation film according to the present invention;

FIGS. 3A and 3B depict the method for inspecting the substrate according to the present invention;

FIGS. 4A and 4B show the method for inspecting the substrate according to the present invention;

FIGS. 5A and 5B present the method for inspecting the substrate according to the present invention;

FIGS. 6A and 6B illustrate the method for inspecting the substrate according to the present invention;

FIG. 7 shows an example of an SEM screen obtained by the method for inspecting the substrate according to the present invention;

FIG. 8 is a schematic view illustrating an example of a substrate inspection apparatus used in the method for inspecting the substrate, according to the present invention;

FIG. 9 illustrates an example of a control unit of the substrate inspection apparatus of FIG. 8;

FIGS. 10A and 10B show an example of data stored in an acceleration voltage table of the control unit of FIG. 9;

FIG. 11 shows an example of the data;

FIG. 12 illustrates an example alignment of a wafer according to the present invention;

FIGS. 13A and 13B depict an example of the data;

FIG. 14 shows an example of the data;

FIGS. 15A and 15B show a substrate to illustrate another example of the method for inspecting the substrate;

FIG. 16 illustrates a substrate to illustrate another example of the method for inspecting the substrate;

FIGS. 17A and 17B depict an example of another substrate used in the method for inspecting the substrate;

FIGS. 18A and 18B illustrate another example of the substrate processed by the inspection method;

FIG. 19 shows the method for inspecting the substrate of FIGS. 18A and 18B;

FIGS. 20A and 20B illustrate another example of the substrate processed by the inspection method;

FIGS. 21A and 21B show the method for inspecting the substrate of FIGS. 20A and 20B;

FIG. 22 depicts the method for inspecting the substrate of FIGS. 20A and 20B; and

FIGS. 23A and 23B show a substrate to illustrate a conventional inspection method.

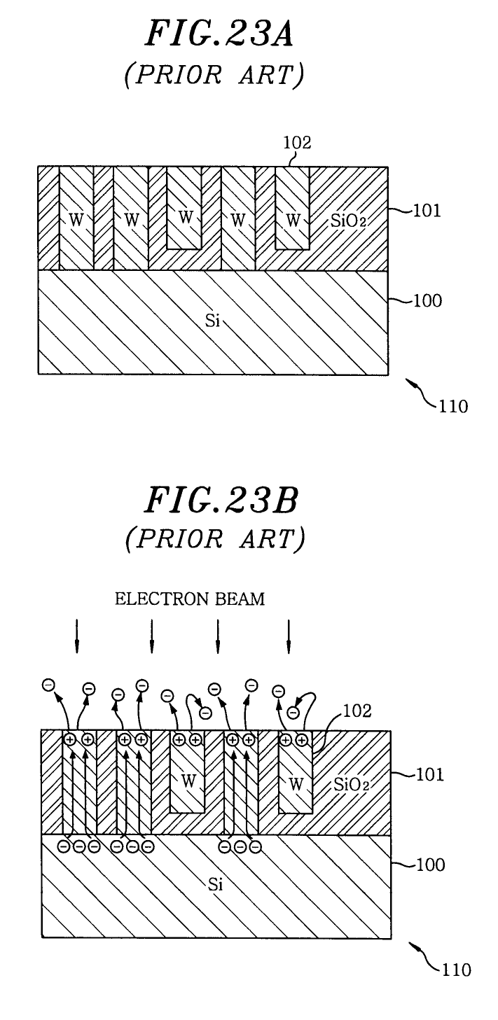

### DETAILED DESCRIPTION OF THE PREFERRED EMBODIMENTS

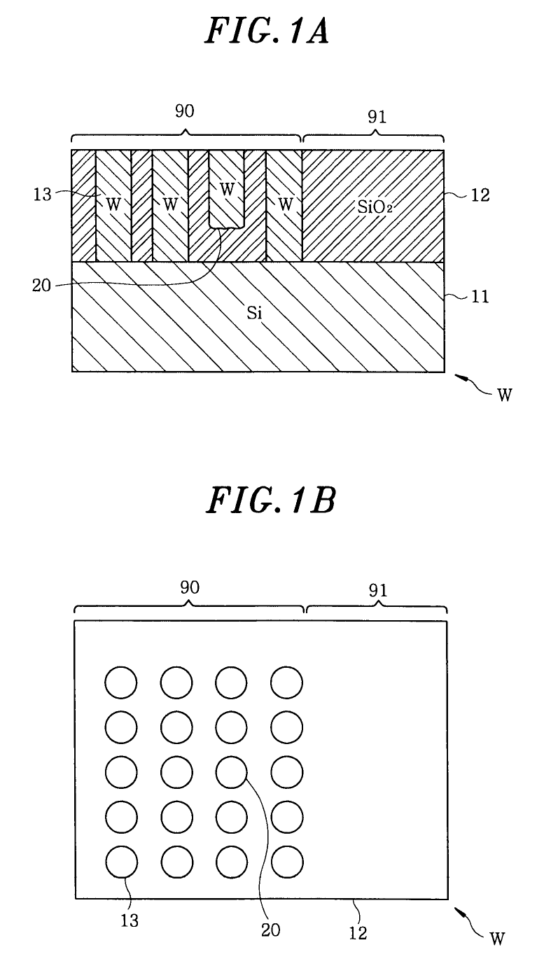

A first embodiment of a method for inspecting a substrate according to the present invention will be described. First, a semiconductor wafer (hereinafter, referred to as “wafer”) which is the substrate processed by the inspection method will be described. FIG. 1A shows a cross-section of a wafer W, in which an insulation film 12, such as a silicon oxide film, is placed on a surface of a conductive film 11, such as a silicon film, having a predetermined conductivity. Depressions, for example, contact holes, are formed in the insulation film 12. Each depression is filled with metal, such as tungsten, thus forming a metal electrode 13. The wafer W has a wiring area 90, in which the metal electrodes 13 are arranged, for example, at regular intervals, and an insulation film area 91 which has no metal electrode 13 and which is formed by increasing a distance between the corresponding adjacent metal electrodes 13. The metal electrodes 13 electrically connect the conductive film 11 to a wiring film, which is placed on the insulation film 12. As shown in FIG. 1B, the upper surfaces of the metal electrodes 13 are exposed outside from the surface of the insulation film 12. Furthermore, some of the metal electrodes 13 may be defective electrodes 20, in which the depression does not reach the upper surface of the conductive film 11 so that the metal electrode 13 is not electrically connected to the conductive film 11.

For example, the wafer W of FIGS. 1A and 1B show an intermediate state in a process of forming a transistor structure, so that a gate electrode formed between the metal electrodes 13 and a source, a drain, etc., formed on the conductive film 11 are omitted in the drawing. In addition, a diameter of each metal electrode 13 and a distance between adjacent metal electrodes 13 are typically expressed in the drawing.

(Characteristics of the Insulation Film)

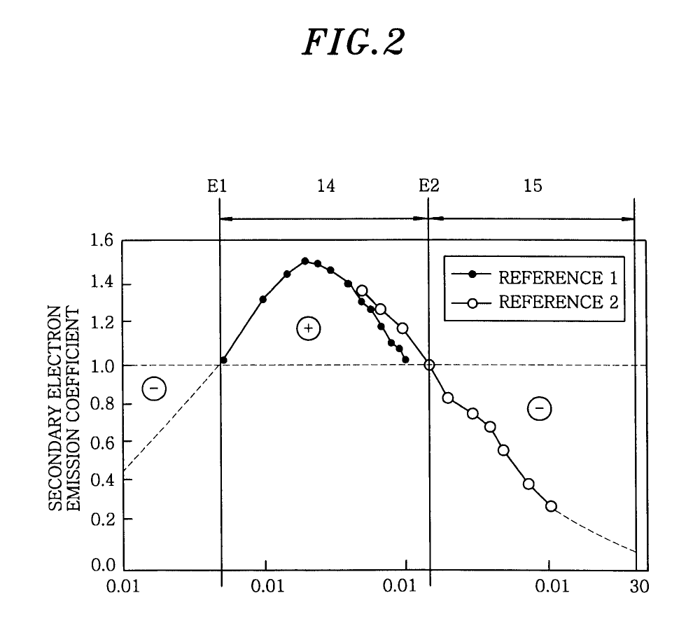

The characteristics of the insulation film will be explained, in which when electron beams are applied to the insulation film 12, the number of secondary electrons emitted from the insulation film 12 is varied depending on acceleration voltage. FIG. 2 is a graph that shows a secondary electron emission coefficient as a function of an acceleration voltage, which refers to Reference 1 (Dionne G F 1975 J. Appl. Phys. 46 3347) and Reference 2. (Joy D C, Joy C S. SEMATECH Report TT#96063130A-TR, August 1996). Herein, the secondary electron emission coefficient is defined by the ratio of the number of emitted electrons to the number of incident electrons.

As shown in FIG. 2, of a range of inspection acceleration voltage that is typically used in an SEM test which will be explained later, in a positive charge range 14 ranging from 0.05 keV to 1 through 2 keV, the number of secondary electrons emitted from the insulation film 12 is increased compared to the number of electrons applied to the insulation film 12. Thus, the insulation film 12 is positively charged up. Meanwhile, in the same manner, of the range of the inspection acceleration voltage, in a negative charge range 15 ranging from 1 through 2 keV to 30 keV and in a range in which acceleration voltage is lower than that in the positive charge range 14, the number of secondary electrons emitted from the insulation film 12 is reduced compared to the number of electrons applied to the insulation film 12. Hence, the insulation film 12 is negatively charged. Furthermore, second acceleration voltages E1 and E2, at which the number of emitted secondary electrons is almost the same as the number of electrons applied to the insulation film 12, are disposed between the above-mentioned ranges. There are differences in the characteristics illustrated in the drawing depending on apparatuses used or composition of the insulation film 12. Therefore, in the present invention, using each apparatus, the characteristics of the insulation film 12 are estimated by previously radiating electron beams onto the insulation film 12 and measuring surface electric potential of the insulation film 12. Thereby, a first acceleration voltage and a second acceleration voltage which will be explained later are set. In addition, in the drawing, the dotted lines are expressed to complement the solid lines.

(Inspection of Wafer)

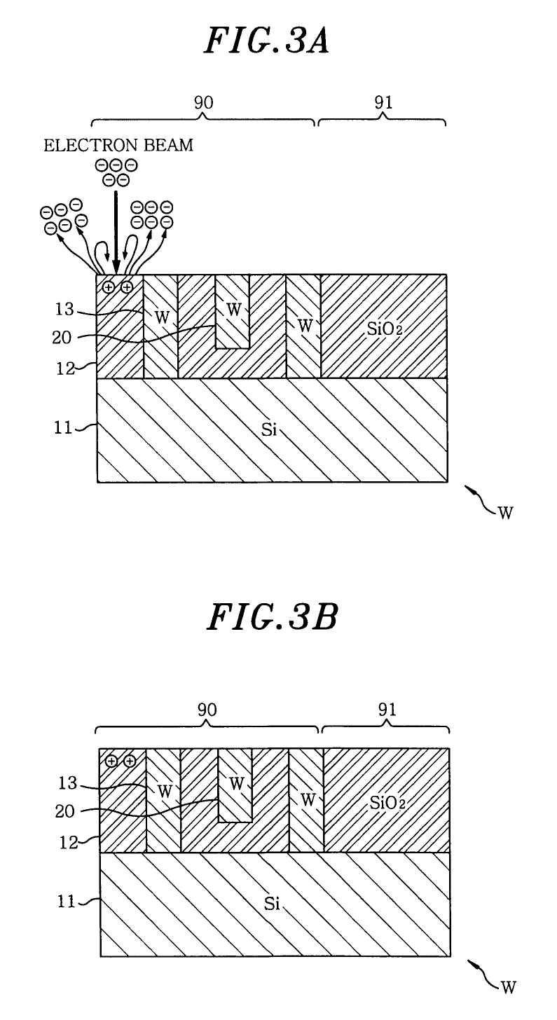

A method of inspecting a substrate according to the present invention will be described with reference to FIGS. 3A through 7. Electron beams are radiated onto the wiring area 90 at an acceleration voltage, for example, 0.8 keV, of the positive charge range 14 of the inspection acceleration voltage range which is the first acceleration voltage. Due to the radiation of the electron beams, secondary voltage and a hole (a positive charge) are generated on the insulation film 12 within the wiring area 90. As shown in FIG. 3A, the number of secondary electrons discharged from the insulation film 12 is greater than the number of incident electrons. Thus, the surface of the corresponding insulation film 12 is positively charged up (see FIG. 3B). Furthermore, because of the positive charge, some of the secondary electrons discharged from the insulation film 12 return, and the remaining secondary electrons are detected by an electron detecting unit 69.

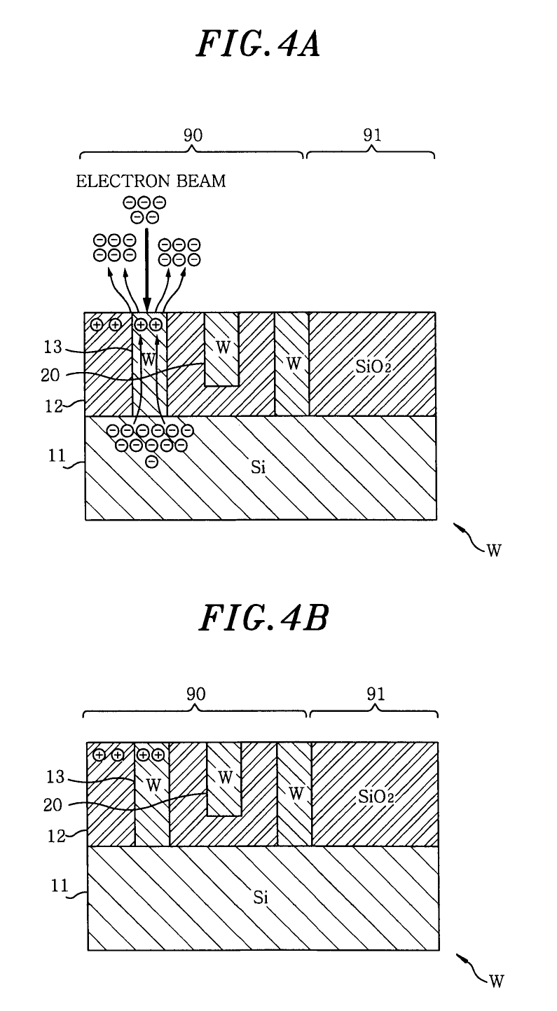

Next, the wafer W is moved and electron beams are applied to metal electrodes 13 at the above-mentioned acceleration voltage. Then, as shown in FIG. 4A, secondary electrons and holes are generated, and the surfaces of the metal electrodes 13 are positively charged up by the discharge of secondary electrons from the surfaces of the metal electrodes 13. As such, when the metal electrodes 13 are positively charged up, electrons rapidly enter the corresponding metal electrodes 13 from the conductive film 11 which is below the metal electrodes 13. Thereby, positive charges are neutralized (see FIG. 4B). The secondary electrons emitted from the metal electrodes 13 are dispersed upwards in a vacuum container 31, and the number of electrons is detected by the electron detecting unit 69. Thereafter, the wafer W is moved in the horizontal direction, and electron beams are sequentially applied to the metal electrodes 13 in the wiring area 90 at the acceleration voltage. Thereby, secondary electrons emitted from the corresponding metal electrodes 13 are detected.

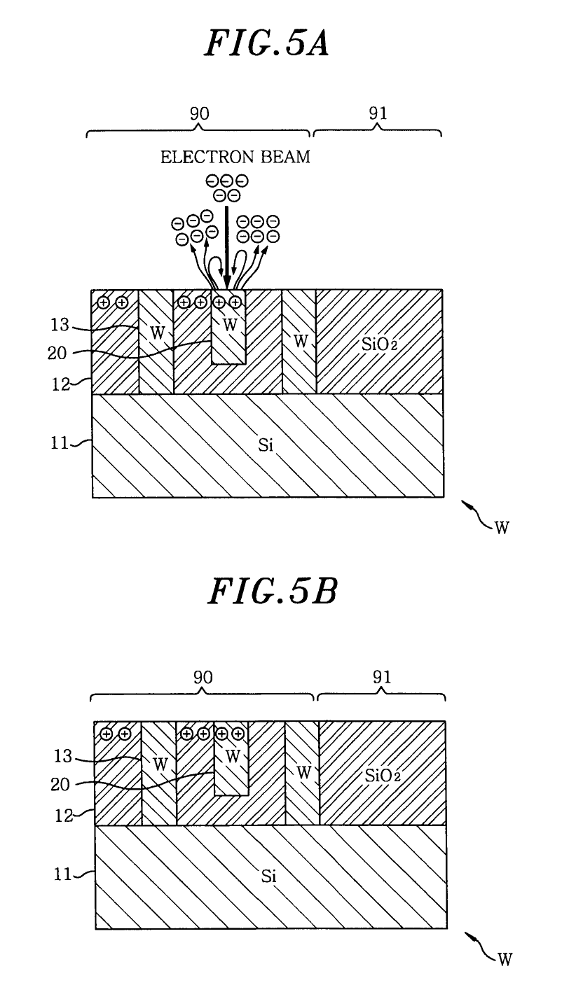

Here, when electron beams are applied to the defective electrode 20, as shown in FIG. 5A, secondary electrons are discharged from the defective electrode 20 in the same manner as that of the normal metal electrodes 13, so that the defective electrode 20 is positively charged. However, because the defective electrode 20 is not electrically connected to the conductive film 11, electrons are not supplied from the conductive film 11 to the defective electrode 20. Therefore, positive charges of the surface of the defective electrode 20 cannot be neutralized (see FIG. 5B). Thus, some of secondary electrons emitted from the defective electrode 20 are returned by these positive charges. Thereby, the number of secondary electrons dispersed upwards from the defective electrode 20 in the vacuum container 31 is less than the number of secondary electrons dispersed from the normal metal electrode 13. As a result, the electron detecting unit 69 detects the number of secondary electrons as being less than that of secondary electrons emitted from the normal metal electrode 13.

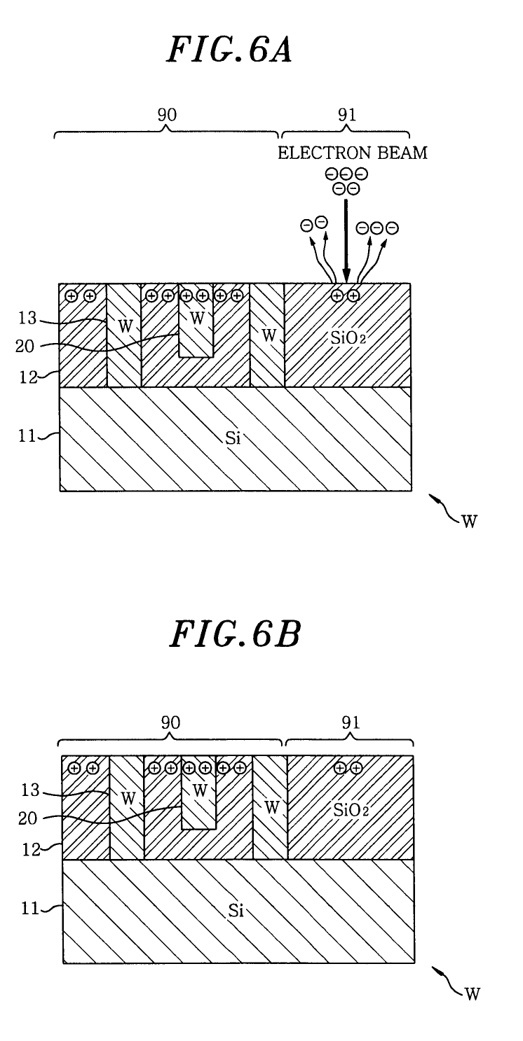

Subsequently, the wafer W is moved in the horizontal direction. When electron beams are applied to the insulation film area 91, the acceleration voltage is converted into a second acceleration voltage E1 (for example, 0.05 keV) or E2 (for example, 1 keV). When electron beams are applied to the insulation film area 91 of the insulation film 12 at this acceleration voltage, secondary electrons and holes are generated, and the secondary electrons are discharged from the insulation film 12. However, as shown in FIG. 6A, because the number of electrons applied to the insulation film 12 is almost the same as the number of secondary electrons, charge-up of the insulation film 12 is restrained, as shown in FIG. 6B.

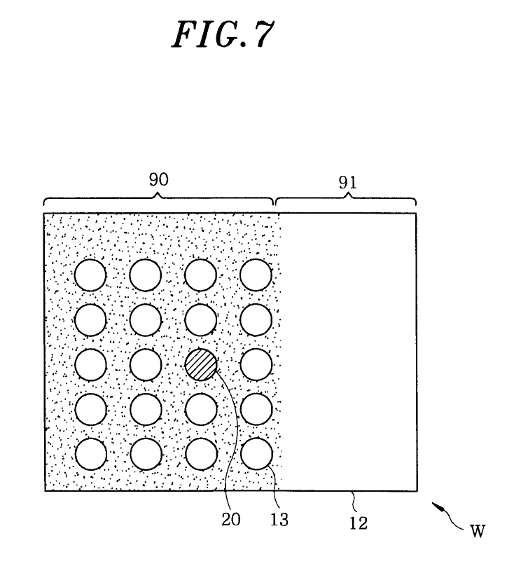

As such, when sequentially applying electron beams to the wiring area 90 and the insulation film area 91 on the wafer W while converting the acceleration voltages, as shown in FIG. 7, the contrast of the secondary electrons between the normal electrodes 13 and the defective electrode 20 in the wiring area 90 becomes remarkable. Furthermore, the wiring area 90 of the insulation film 12 is positively charged up, but the charge-up of the insulation film area 91 of the insulation film 12 is restrained. In addition, for simplification of description, FIGS. 3A through 6B are conceptual diagrams as FIG. 1, and the contrast is exaggerated for ease of discrimination.

(Construction of Apparatus)

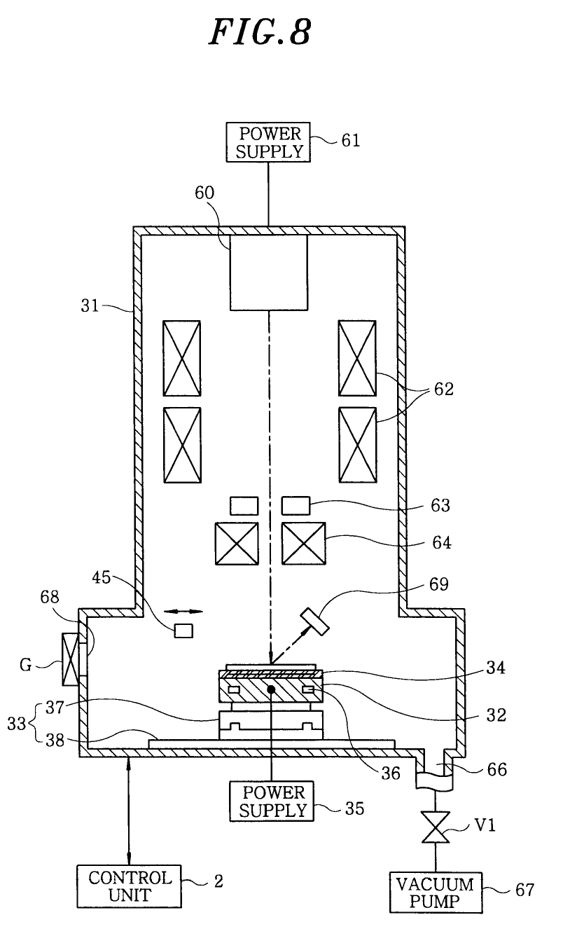

An example of a substrate inspection apparatus for performing the method for inspecting a substrate will be described with reference to FIG. 8. In the drawing, the reference numeral 31 denotes a vacuum container. A mounting table 32, onto which the wafer W is placed, is provided at a lower position in the vacuum container 31. An XY driving system 33 is provided under the mounting table 32 and includes an X-axial actuator 37 and a Y-axial actuator 38. An encoder 40 (not shown in FIG. 8) is provided in the XY driving system 33. A control unit 2 which will be explained later reads the number of pulses of the encoder 40. Thereby, in an operating coordinate system, a coordinate position, for example, center coordinates, of the mounting table 32 with respect to the horizontal direction is obtained.

An electrostatic chuck 34 which electrostatically adsorbs the wafer W is provided on the surface of the mounting table 32. Furthermore, a lift pin (not shown) is provided in the mounting table 32. The mounting table 32 transports or receives the wafer W to or from an external substrate supply unit (not shown) using the lift pin. In addition, the mounting table 32 has therein a cooling unit 36 which cools the wafer W which is heated by radiation of electron beams. For example, the cooling unit 36 is constructed such that a refrigerant circulates between the cooling unit 36 and the exterior of the vacuum container 31, and the cooling unit 36 absorbs heat from the wafer W using gas, which is supplied to the rear surface of the wafer W through a gas supply hole (not shown) formed in the upper surface of the mounting table 32. A power supply 35 is connected to the mounting table 32 to apply negative voltage to the wafer W. The power supply 35 functions to reduce the speed of electron beams (primary electrons) emitted around the wafer W.

Furthermore, an electron emitting unit 60 which radiates electron beams onto the wafer W is provided under a ceiling in the vacuum container 31 such that it faces the mounting table 32. A power supply 61 for applying negative voltage is connected to the electron emitting unit 60. The difference in voltages between the power supply 61 and the power supply 35 of the mounting table 32 becomes an acceleration voltage of electron beams radiated onto the wafer W. As well, a focusing lens 62, which collects electrons beams emitted from the electron emitting unit 60, an iris diaphragm 63, which limits a range within which electron beams pass, and a scanning coil 64, which scans electron beams, are provided between the electron emitting unit 60 and the mounting table 32. The electron detecting unit 69, which detects secondary electrons discharged from the wafer W by radiation of electron beams, is provided between the mounting table 32 and the scanning coil 64. Furthermore, an image capturing unit 45, such as a camera, which images arrangement of chips formed on the surface of the wafer W on the mounting table 32 or markers for dicing, is provided between the mounting table 32 and the scanning coil 64. The image capturing unit 45 is movably provided in the horizontal direction by an actuator (not shown).

An exhaust port 66 is formed in the bottom of the vacuum container 31. A vacuum pump 67 is coupled to the exhaust port 66 via a valve V1. A transfer port 68 is formed through the sidewall of the vacuum container 31. The wafer W is supplied into the vacuum container 31 through the transfer port 68.

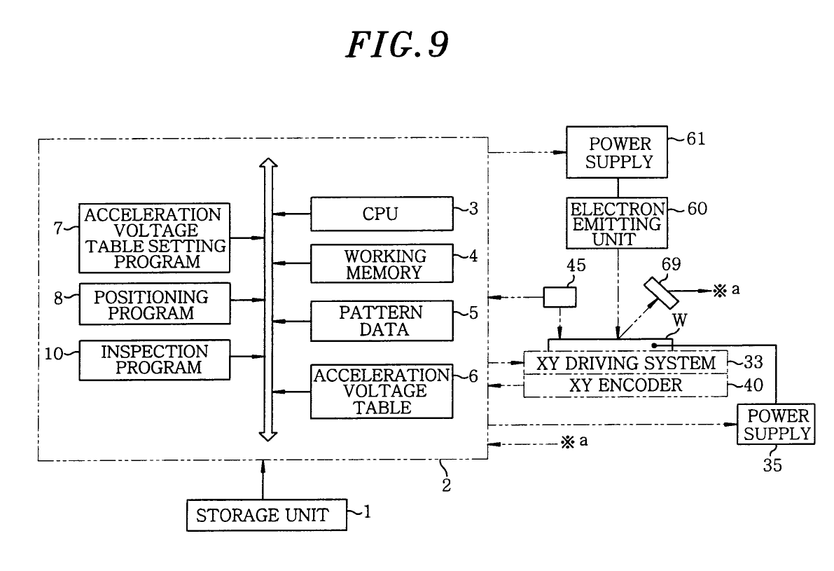

As shown in FIG. 9, the substrate inspection apparatus includes the control unit 2, which comprises, for example, a computer. The control unit 2 includes a CPU 3, a memory 4, pattern data storage 5 and an acceleration voltage table 6. Furthermore, the control unit 2 includes an acceleration voltage table setting program 7, a positioning program 8 and an inspection program 10. The memory 4 has a part which records inspection parameters, such as an acceleration voltage of electron beams radiated onto the wiring area 90 and the insulation film area 91 of the wafer W, pressure and temperature in the vacuum container during inspection.

The pattern data storage 5 stores, as stored data, coordinates on the wafer W which indicates arrangement of the wiring area 90 and the insulation film area 91 of the wafer W to be inspected. Such stored data is previously obtained from design data which is pattern information of a photo resist pattern which is used when forming the depressions in which the metal electrodes 13 are embedded. In detail, the stored data is coordinates in the X-Y coordinate system corresponding to longitudinal and transverse arrangement of integrated circuit chips provided on the surface of the wafer. For example, the stored data is stored as information corresponding to whether integrated circuit chips are present. In other words, an area in which integrated circuit chips are formed are stored as the wiring area 90, and an area between the integrated circuit chips is stored as the insulation film area 91. For example, this stored data is stored after it is converted into an actuating amount of the XY driving system 33 such that it corresponds to a coordinate position in the operating coordinate system of the mounting table 32.

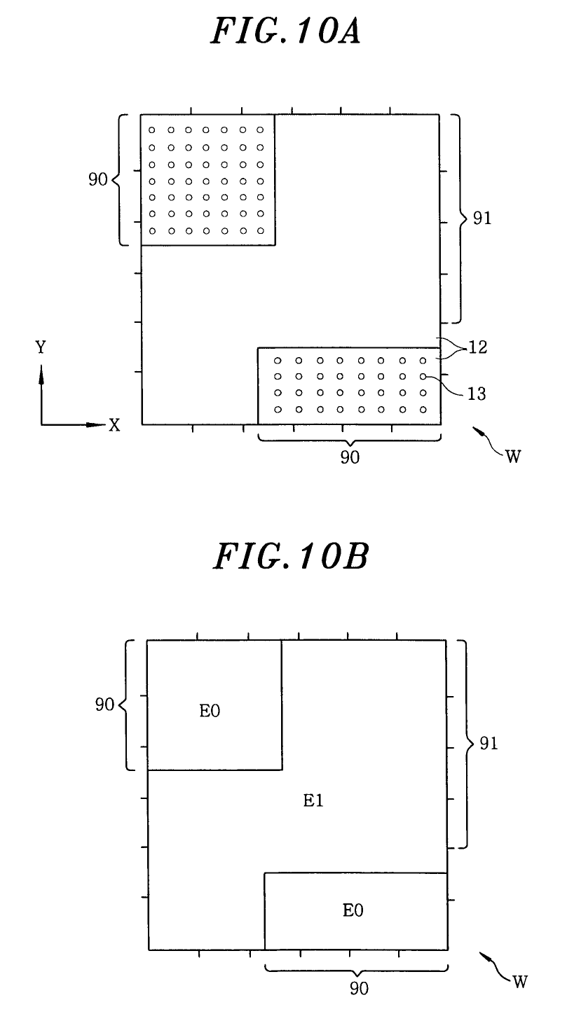

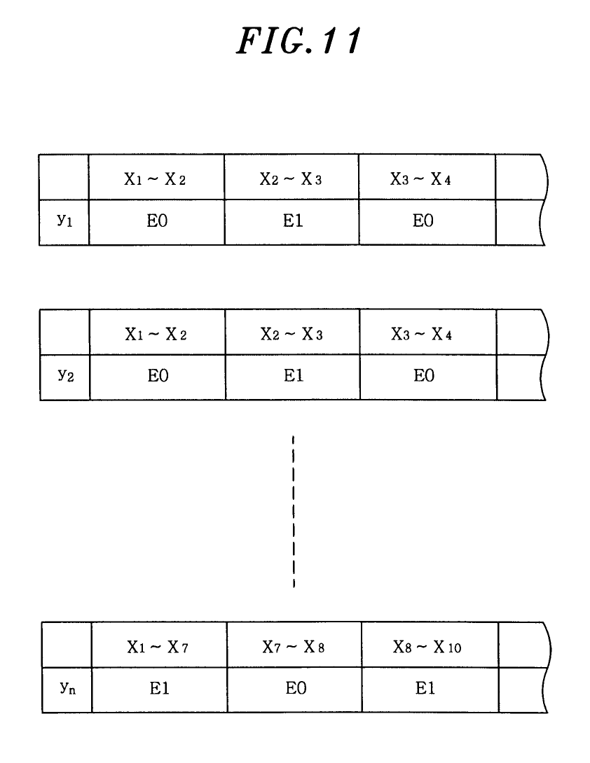

The acceleration voltage table 6 functions to store acceleration voltage of electron beams radiated onto the wafer W. For example, information about acceleration voltage is set depending on whether the integrated circuit chips are present is stored in the acceleration voltage table 6, such that electron beams are radiated onto the wiring area 90 of the wafer W at inspection acceleration voltage and electron beams are radiated onto the insulation film area 91 of the wafer W at second acceleration voltage E1 or E2. In detail, the acceleration voltage table 6 is written by the acceleration voltage table setting program 7 based on information stored in the pattern data storage 5. For example, in the case where areas which include metal electrodes 13 showing integrated circuit chips are arranged in a manner shown in FIG. 10A, imaging treatment is performed such that a section line is set at a position spaced apart from a perimeter of each group of metal electrodes 13 by a predetermined distance based on imaging data, such as CAD data, showing the arrangement of the metal electrodes 13. Areas including the metal electrodes 13 are determined as wiring areas 90, and an area between the wiring areas 90 is determined as an insulation film area 91. Furthermore, as shown in FIG. 10B, in the case where inspection acceleration voltage is set as, for example, E0, the acceleration voltage in the wiring area 90 is set as E0, and the acceleration voltage in the insulation film area 91 is set as E1 or E2. Information obtained by corresponding these acceleration voltages to the operating coordinate system of the mounting table 32 is stored as the acceleration voltage table 6. Here, FIGS. 10A and 10B is a view typically showing portion of the surface of the wafer W. In addition, the acceleration voltage table 6 may be numerically stored, as shown in FIG. 11.

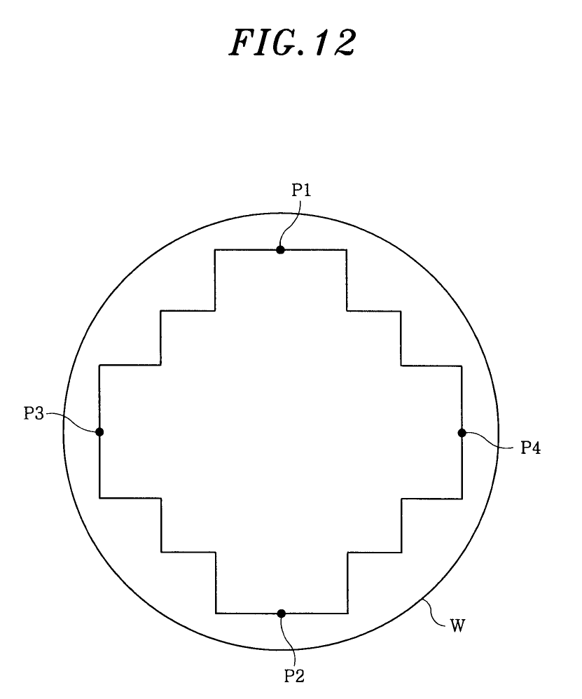

The positioning program 8 functions to control the position of the mounting table 32 such that when electron beams are radiated onto the wafer W based on the acceleration voltage stored in the acceleration voltage table 6, the actual coordinates of the wafer W placed on the mounting table 32 are prevented from deviating from the coordinates of the wafer W stored in the pattern data storage 5. In detail, as shown in FIG. 12, the image capturing unit 45 images specific points P1 through P4, such as alignment marks, for example, dicing marks for dicing chips, which are formed at four points spaced apart from each other at regular angular intervals on the perimeter of the surface of the wafer W on the mounting table 32, or for example the integrated circuit chips as the coordinate positions. Based on the result of the imaging process, X-Y coordinate axes on the wafer W are determined. X-Y coordinate axes of the operating coordinate system of the mounting table 32 are determined such that they are parallel to the X-Y coordinate axes on the wafer W. Thereby, the mounting table 32 can be moved along the X-Y coordinate axes on the wafer W. From the actuating amount of the XY driving system 33 when imaging the specific points P1 through P4, the number of pulses of the encoder 40 per a unit moving amount of the mounting table 32 is calculated. By obtaining the number of pulses of the encoder 40 and a distance ratio between the specific points, relationship between a distance on the wafer W, such as a distance between the integrated circuit chips, and the actuating amount of the XY driving system 33 is obtained.

The inspection program 10 determines an acceleration voltage based on the acceleration voltages which have been stored in the acceleration voltage table 6 and radiates electron beams onto the wafer W. In addition, the inspection program 10 inspects whether the metal electrodes 13 are defective in such a way as to detect the number of secondary electrons emitted from the metal electrodes 13. Furthermore, the inspection program 10 images a specific point, for example, P1, and determines an inspection start position from the result of the imaging process and relationship between the coordinate position on the wafer W obtained by the positioning program 8 and the actuating amount of the XY driving system 33. Thereafter, the inspection program 10 moves the mounting table 32 to the inspection star position, reads acceleration voltages from the acceleration voltage table 6, and moves the mounting table 32 while radiating electron beams onto the wafer W.

These programs 7, 8 and 10 (including programs pertaining to input of process parameters or display) are stored in a storage unit 1, which is a storage medium of the computer, for example, a flexible disk, a compact disk, a hard disk or an MO (magneto-optical disk), and are installed in the control unit 2.

The operation of the substrate inspection apparatus will be explained. First, the wafer W is supplied into the vacuum container 31 by the substrate supply unit (not shown) and is placed onto the mounting table 32. Thereafter, the wafer W is eletrostatically adsorbed by the mounting table 32 and, simultaneously, the temperature of the mounting table 32 is adjusted such that the wafer W is maintained at a predetermined temperature. Furthermore, the interior of the vacuum container 31 is set to a predetermined degree of vacuum. Subsequently, the image capturing unit 45 images specific points, for example, P1 and P2, on the wafer W. Based on the specific points, X-Y coordinate axes on the wafer W are determined from arrangement of integrated circuit chips on the wafer W. X-Y coordinate axes of the operating coordinate system of the mounting table 32 are determined such that they are parallel to the X-Y coordinate axes on the wafer W.

Thereafter, the image capturing unit 45 images a specific point, for example, P1, and the mounting table 32 is moved such that an inspection start position on the wafer W is disposed right below the electron emitting unit 60. An acceleration voltage is read from the acceleration voltage table 6, and an order value of the acceleration voltage depending on the coordinates of the mounting table 32 is output to the power supplies 35 and 61. Due to this, when the wiring area 90 is disposed right below the electron emitting unit 60 from which electron beams are radiated onto the wafer W, the voltages of the power supplies 35 and 61 are set, for example, to −11.2 kV and −12 kV, and electron beams of 0.8 keV are radiated onto the wiring area 90. At this time, the electron detecting unit 69 detects the number of secondary electrons emitted from the wiring area 90. When the insulation film area 91 is disposed right below the electron emitting unit 60, the voltages of the power supplies 35 and 61 are set, for example, −11.95 kV and −12 kV or −11 kV and −12 kV, and the acceleration voltage is converted into E1 or E2. As such, the XY driving system 33 is operated and, simultaneously, the acceleration voltage is converted when radiating electron beams onto the wiring area 90 and when radiating electron beams onto the insulation film area 91. Thereby, the entire area of the wafer W is inspected.

According to the above embodiment, whether the metal electrodes 13 embedded in the depressions formed in the insulation film 12 of the surface of the wafer W are electrically connected to the conductive film 11 formed below the insulation film 12 is inspected in such a way as to detect the number of secondary electrons emitted from the wafer W by radiating electron beams onto the surface of the wafer W. In this inspection, based on arrangement of the wiring areas 90 where the metal electrodes 13 are clustered close together and the insulation film area 91 which has no metal electrodes, electron beams are radiated onto the wiring areas 90 at an inspection acceleration voltage which is a first acceleration voltage which increases contrast of secondary electrons between the defective electrode 20 and the normal metal electrodes 13, and electron beams are radiated onto the insulation film area 91 at a second acceleration voltage at which a difference between the number of incident electrons and the number of emitted secondary electrons is smaller than at the first acceleration voltage, thereby restraining charge-up of the insulation film 12. Due to this, in the wiring areas 90, the defective electrode 20 can be easily detected. In the insulation film area 91, the charge-up of the insulation film 12 can be restrained. Therefore, variation in contrast or brightness attributable to the charge-up and deviation of dimensions can be prevented.

As such, unlike using a method of removing electric charges of the insulation film 12 that is charged-up once, in the insulation film area 91, acceleration voltage is converted such that the insulation film 12 is not charged-up or the amount of charge-up is reduced by radiation of electron beams, so that, for example, even when inspecting the wafer W, the charge-up of the insulation film area 91 can be prevented.

Furthermore, the present invention is constructed such that acceleration voltage is converted when radiating electron beams onto the wiring areas 90 including the metal electrodes 13 and when radiating electron beams onto the insulation film area 91 having no metal electrode but not such that acceleration voltage is converted when radiating electron beams onto the metal electrodes 13 and the insulation film 12. Therefore, because it is not required to finely convert acceleration voltage, charge-up of the entire wafer W can be easily prevented.

In the embodiment, although the second acceleration voltage E1 or E2 is used when radiating electron beams onto the insulation film area 91, acceleration voltage around E1 or E2 may be used, and it is preferable that acceleration voltage which can reduce a secondary electron emission coefficient compared to that of the acceleration voltage when radiating electron beams onto the wiring area 90 be used. Here, the acceleration voltage is determined within a range of from 0.05 keV to 0.5 keV or from 1 keV to 3 keV such that the secondary electron emission coefficient ranges from 0.8 to 1.2. Charge-up of the entire wafer W can be restrained by setting the acceleration voltage in the above manner. There may be a difference in acceleration voltage depending on the used apparatus or composition of the insulation film 12. Therefore, the acceleration voltage is to be appropriately set such that the above-mentioned secondary electron emission coefficient is obtained.

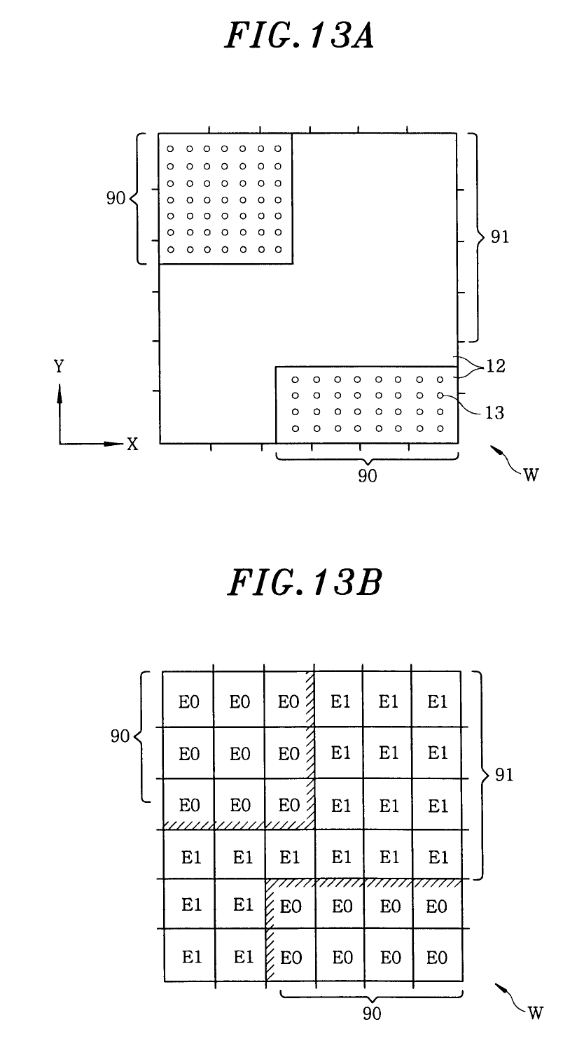

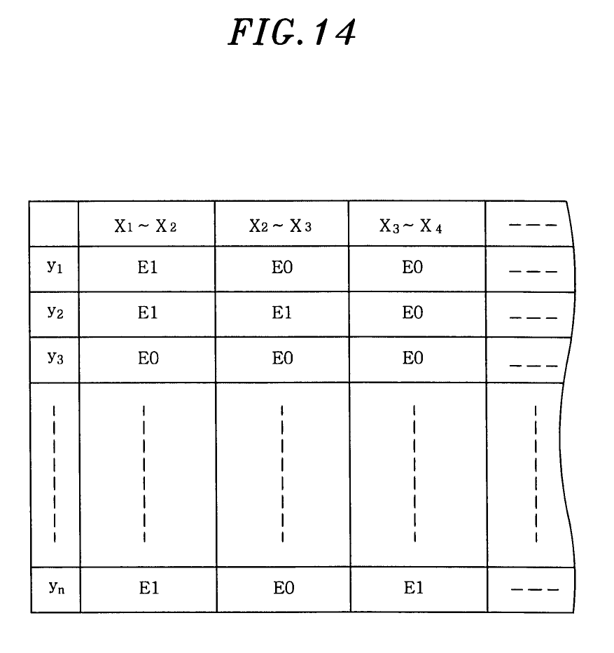

As a method of sectioning the area of the wafer W into the wiring areas 90 and the insulation film area 91 when storing the acceleration voltage in the acceleration voltage table 6, the sectioning process may be performed based on the arrangement of the groups of metal electrodes 13. Alternatively, as shown in FIGS. 13A and 13B, the sectioning process may be performed in such a way that the surface of the wafer W is partitioned into several portions in a squared shape, and portions containing the metal electrodes 13 are determined as the wiring areas 90, and the remaining portions having no metal electrode 13 are determined as the insulation film area 91. In this case, the size of the wiring areas 90 and the insulation film area 91 may slightly vary from those of the former example, but the areas 90 and 91 can be easily determined. Furthermore, the acceleration voltage table 6 may also be numerically stored, as shown in FIG. 14, in place of the case of FIG. 13B. In the above methods of sectioning the surface of the wafer W into the wiring areas 90 and the insulation film area 91, although the sizes of the areas 90 and 91 may vary slightly, both methods can perform inspection of the metal electrodes 13 and restrain charge-up of the insulation film area 91. FIG. 13A is a conceptual diagram showing an enlargement of portion of the surface of the wafer W.

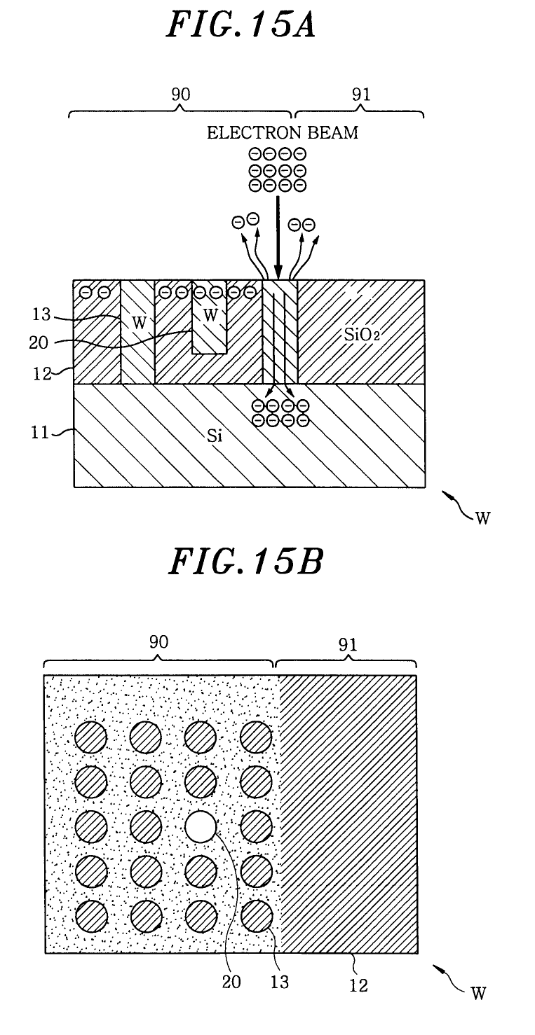

In the above embodiment, although the inspection has been illustrated as being conducted using acceleration voltage by which the metal electrodes 13, the defective electrode 20 and the insulation film 12 are positively charged up, the inspection may be conducted using acceleration voltage of a negative charge range 15. In this case, electrons which are applied to a normal metal electrode 13 flow into the conductive film 11 which is disposed under the metal electrode 13. Thus, negative charge-up of the metal electrode 13 is restrained. However, in the case of a defective electrode 20, electrons accumulate in the defective electrode 20. Hence, the defective electrode 20 is negatively charged up. Thus, in both portions, contrast of secondary electrons is increased. Furthermore, as shown in FIG. 15B, the wiring area 90 of the insulation film 12 is negatively charged up, but negative charge-up of the insulation film area 91 of the insulation film 12 is restrained by radiating electron beams thereonto at acceleration voltage E1 or E2. Therefore, the same effects as the former example can be obtained. Here, in FIG. 15A, for simplification of the description, the sizes of the metal electrodes 13 are simplified, and the contrast is exaggerated for ease of discrimination.

In conversion of acceleration voltage between the wiring area 90 and the insulation film area 91, although each acceleration voltage has been illustrated as being determined based on information stored in the pattern data storage 5, a user may, for example, monitor an SEM image and vary the acceleration voltage. Furthermore, in the process in which electron beams scan the wafer W, the mounting table 32 has been illustrated as being moved, the focusing lens 62, the iris diaphragm 63 or the scanning coil 64 may be moved in the horizontal direction.

The present invention is accomplished based on the fact that it is necessary to radiate electron beams onto the metal electrodes 13 (including a defective electrode 20), which are targets to be inspected, at an acceleration voltage which is suitable for inspection, but it is unnecessary to radiate electron beams onto the insulation film 12 (in detail, the insulation film area 91) which is not a target to be inspected, at an inspection acceleration voltage.

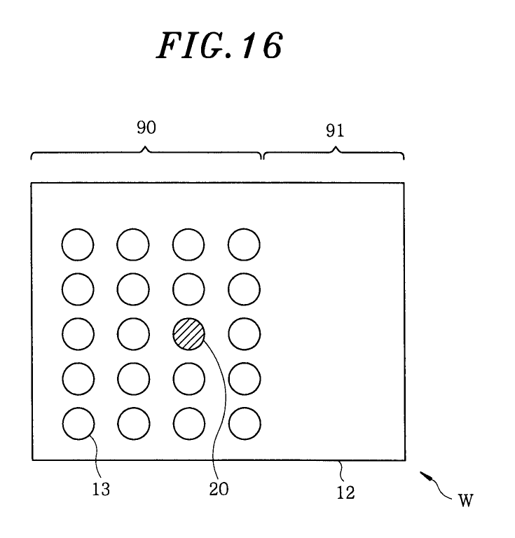

In the above embodiment, although electron beams have been illustrated as being radiated onto the insulation film 12 in the wiring area 90 at inspection acceleration voltage, electron beams may be radiated onto the insulation film 12 in the wiring area 90 at acceleration voltage E1 or E2. In the adjustment of the acceleration voltage, as pattern information, coordinates of the metal electrodes 13 that are exposed outside from the surface of the insulation film 12, for example, information that is previously obtained from design data of the photo resist pattern, are used. In this case, as shown in FIG. 16, charge-up of the insulation film 12 can be restrained even in the wiring area 90.

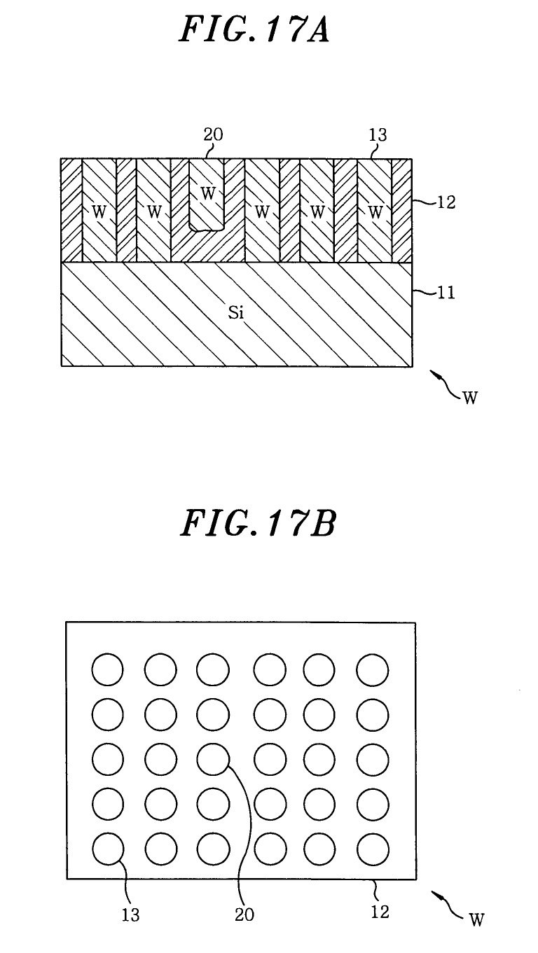

As such, in the case where the acceleration voltage is converted such that charge-up of the insulation film 12 in the wiring area 90 is prevented, for example, as shown in FIGS. 17A and 17B, the inspection method according to the present invention can be applied to a wafer W in which metal electrodes 13 are evenly arranged on the entire area thereof. In this case, charge-up of the insulation film 12 can also be restrained, and a defective electrode 20 can be easily detected.

Furthermore, the inspection method of the present invention has been illustrated as being used in the process of forming a transistor structure, it may be used in the inspection of metal wiring, which is embedded in a via hole or a hole of a trench formed in an interlayer dielectric and is made of copper or aluminum.

In addition, in the example of FIG. 1, although the wafer W in which the metal electrodes 13 are not formed on the insulation film area 91 has been illustrated for illustrative purposes, metal patterns 80 which do not need their conduction with the conductive film 11 to be inspected may be formed in the insulation film area 91. As an example of the metal patterns 80, there is a mark for indicating the orientation or center of the wafer W or a metal wiring which does not require inspection because the incidence of defect is very low. In detail, there are the examples of an alignment mark for adjusting the orientation of the wafer W, a dicing mark for dicing an electrode chip including the wiring area 90, and an electrode which is formed on the periphery of the electrode chip to electrically connect the electrode chip and a wiring substrate to which the diced electrode chip is bonded. Therefore, generally, the density of the metal patterns 80 formed in the insulation film area 91 is less than that of the metal electrodes 13 formed in the wiring area 90. Due to this, when inspecting this type of wafer W, acceleration voltage of electron beams is adjusted in the following manner in order to restrain charge-up of the insulation film area 91 having the metal patterns 80.

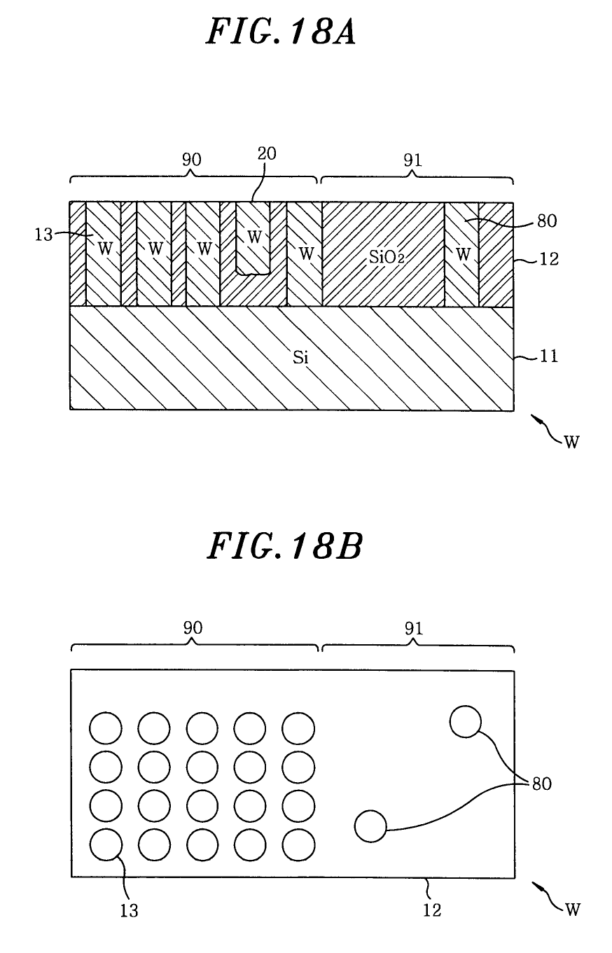

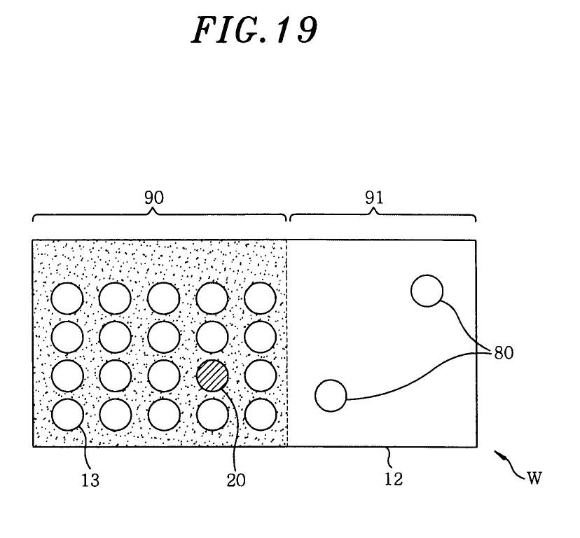

First, this type of wafer W will be explained with reference to FIGS. 18A and 18B. In the same manner as the example of FIG. 1, in the wafer W, the insulation film 12 is applied to the upper surface of the conductive film 11. The metal electrodes 13 are formed by embedding metal, such as tungsten, in depressions formed in the insulation film 12. Furthermore, the wafer W has the wiring area 90 in which the metal electrodes 13 are arranged at regular intervals, and the insulation film area 91 in which the metal patterns 80 are embedded. Each metal pattern 80 may actually be a cross-shaped mark, a linear mark or a wiring which has an area greater than that of the metal electrode 13. In addition, the metal pattern 80 may be formed on only the surface of the insulation film 12, but, in FIGS. 18A and 19, for the sake of description, the metal pattern 80 is expressed as having the same size as the metal electrode 13.

In the same manner as the above-stated example, electron beams are radiated onto the wiring area 90 at inspection acceleration voltage (the first acceleration voltage). When radiating electron beams onto the insulation film area 91, the acceleration voltage is converted into a second acceleration voltage E1 or E2. Then, as shown in FIG. 19, in the wiring area 90, a large contrast of secondary electrons is obtained between the normal metal electrodes 13 and a defective electrode 20. Furthermore, the wiring area 90 of the insulation film 12 is positively charged up, but the insulation film area 91 of the insulation film 12 is restrained from being charged up. Hence, in the wiring area 90, the defective electrode 20 can be easily detected. In the insulation film area 91, the charge-up of the insulation film 12 can be restrained. As a result, variation in contrast or brightness attributable the charge-up and deviation of dimensions can be prevented.

Furthermore, although the metal patterns 80 but not metal electrodes 13 have been illustrated as being formed in the insulation film area 91, the inspection method of the present invention may be applied to a wafer W in which metal electrodes 13 are formed in the insulation film area 91 such that a density of the metal electrodes 13 formed in the insulation film area 91 is lower than that of the wiring area 90. In this case, the metal electrodes 13 formed in the insulation film area 91 are not targets to be inspected, so that electron beams are radiated onto the metal electrodes 13 formed in the insulation film area 91 at the second acceleration voltage. In this example, a defective electrode 20 in the wiring area 90 can also be easily detected, and charge-up of the insulation film area 12 in the insulation film area 91 can be restrained. As such, to obtain the above effects, in the inspection method of the present invention, electron beams are radiated onto a portion (not a target to be inspected), which is easily charged-up, at second acceleration voltage. Electron beams are radiated onto a target to be inspected at a first acceleration voltage.

Moreover, the inspection of the wafer W may be conducted using an acceleration voltage of a negative charge range 15, as shown in FIGS. 15A and 15B. Alternatively, as shown in FIG. 16, the inspection may be conducted such that the insulation film 12 in the wiring area 90 is prevented from being charged up.

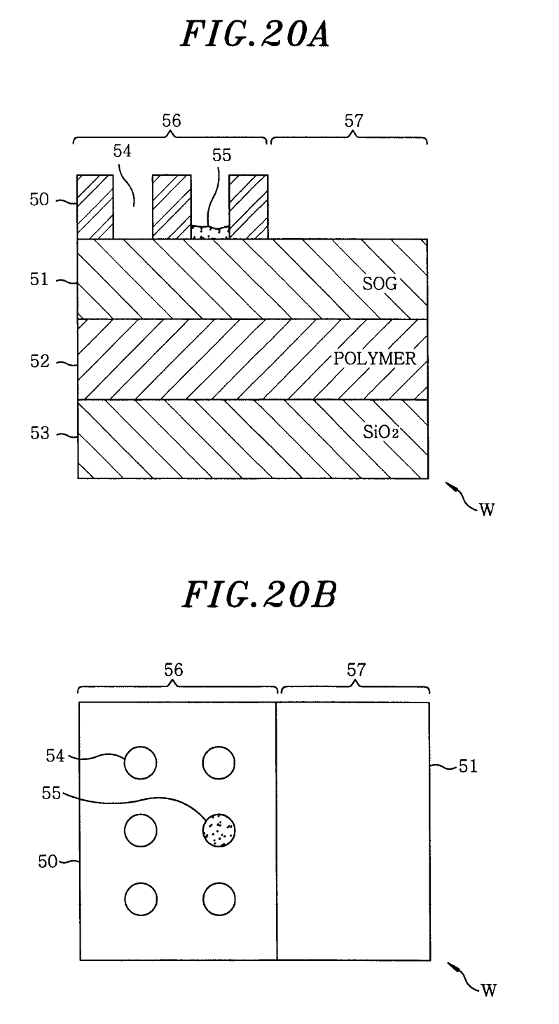

Meanwhile, the inspection method of the present invention may be used for a wafer W, in which a photo resist mask 50 which is made of an organic film is applied to an insulation film, for example, a SOG (spin on glass) film 51 which is a coating film made of SiO₂, as shown in FIGS. 20A and 20B. In this example, the wafer W has a patterned area 56 which has the photo resist mask 50, and an insulation film area 57, through which the SOG film 51 is exposed outside by forming no photo resist mask 50 or removing the photo resist mask 50. Depressions 54, such as holes, are patterned in the photo resist mask 50. A residue 55 of the photo resist mask 50 which occurs in a lithography or developing process of the pattern may be applied to the bottom of the depression 54. Whether a residue 55 exists is inspected in the following manner. Furthermore, under the SOG film 51, a polymer film 52 which is an insulation film and is made of organic material, and an SiO₂ film 53 which is an insulation film are placed in positional sequence from the top to the bottom to generate a laminated structure.

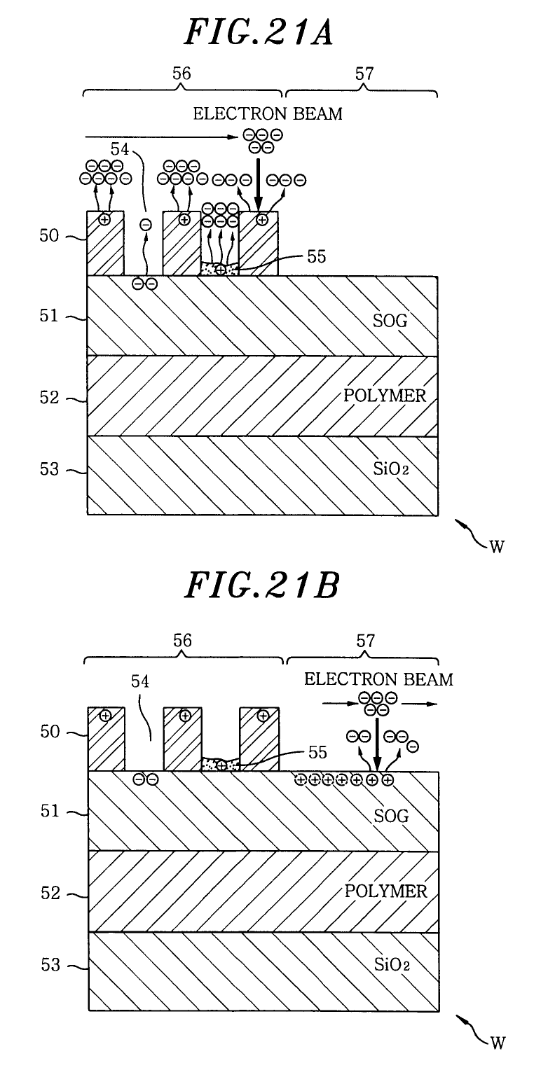

As shown in FIG. 21A, electron beams are radiated onto the patterned area 56 at inspection acceleration voltage (first acceleration voltage), for example, 1.2 eV, which increases the difference in brightness of secondary electrons between the SOG film 51 and the residue 55. At this time, the voltages of the power supplies 35 and 61 are respectively set as −10.8 kV and −12 kV. By the radiation of electron beams, electrons are accumulated in portions of the SOG film 51 which are exposed outside through the depressions 54, so that the exposed portions of the SOG film 51 are negatively charged up. On the other hand, in the depression 54 having the residue 55, an emission amount of secondary electrons is greater than the number of incident electrons. Therefore, the residue 55 is positively charged up. As well, the surface of the photo resist mask 50 is positively charged up in the same manner as that of the residue 55.

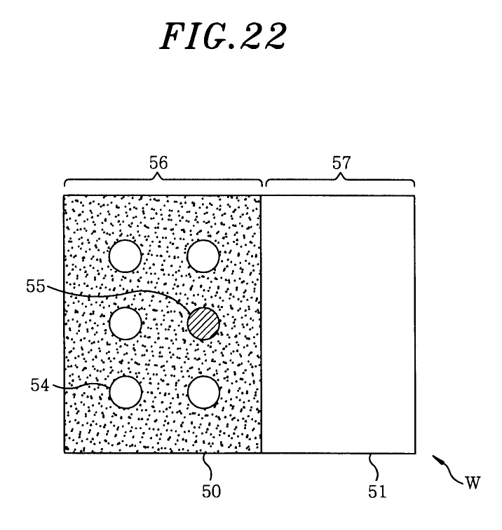

As shown in FIG. 21B, electron beams are radiated onto the insulation film area 57 at a second acceleration voltage, for example, 1 keV, in the same manner as that of the above-stated example. At this time, the voltages of the power supplies 35 and 61 are respectively set as −11 kV and −12 kV. As stated above, at this acceleration voltage, the number of electrons entering the SOG film 51 becomes almost the same as the number of secondary electrons emitted from the SOG film 51. Thus, the insulation film area 57 of the SOG film 51 is prevented from being charged up. As such, by varying the acceleration voltage while electron beams are sequentially radiated onto the patterned area 56 and the dielectric are 57 of the wafer W, in the pattern area 56, a large contrast of second electrons is obtained between the residue 55 and the portions of the SOG film 51 that are exposed through the depressions 54, as shown in FIG. 22. Furthermore, in the patterned area 56, the SOG film 51 (the bottoms of the depressions 54) are negatively charged up, but, in the insulation film area 57, the SOG film 51 is prevented from being charged up.

In this example, electron beams are radiated onto the pattern area 56 at an acceleration voltage which can detect whether the residue 55 is present, and electron beams are radiated onto the insulation film area 57 at an acceleration voltage which can prevent the insulation film area 57 from being charged up. Therefore, in the patterned area 56, the residue 55 can be easily detected. In the insulation film area 57, the insulation film 51 can be prevented from being charged up. As a result, variation in contrast or brightness attributable the charge-up and deviation of dimensions can be prevented.

Furthermore, although the portions of the SOG film 51 that are exposed outside through the depressions 54 have been illustrated as being negatively charged up and the residue 55 has been illustrated as being positively charged up, the acceleration voltage may be adjusted such that any one of the SOG film 51 and the residue 55 may be negatively charged up while a remaining one of the SOG film 51 and the residue 55 may be positively charged up. In addition, both the SOG film 51 and the residue 55 are dielectric, but the materials (compositions) thereof differ from each other. Thus, the acceleration voltage can be adjusted such that even though the both are charged up to the same pole (positively or negatively), a contrast of secondary electrons sufficient to distinguish the residue 55 from the normal depressions 54 can be obtained.

Moreover, in the same manner as the above-mentioned example (of FIG. 16), electron beams may be radiated onto the SOG film 51 in the pattern area 56 at a second acceleration voltage, thus preventing charge-up of the corresponding portions of the SOG film 51.

As described above, the method for inspecting a substrate according to the present invention can be applied not only to an inspection between a conductive film and an insulation film of a wafer W but also to an inspection between insulation films.

While the invention has been shown and described with respect to the preferred embodiment, it will be understood by those skilled in the art that various changes and modifications may be made without departing from the scope of the invention as defined in the following claims.

What is claimed is:

1. A method for inspecting a substrate by radiating electron beams onto a surface of the substrate including a conductive film and an insulation film that are placed in positional sequence from a bottom to a top and to detect the number of secondary electrons emitted from a surface of a metal electrode embedded in a depression formed in the insulation film so as to inspect whether the metal electrode is electrically connected to the conductive film, the method comprising:
placing the substrate onto a mounting table;
inspecting whether the metal electrode is electrically connected to the conductive film by radiating electron beams onto an area of the substrate including the metal electrode at a first acceleration voltage and detecting secondary electrons emitted from the metal electrode; and
radiating electron beams onto an area of the substrate not including the metal electrode at a second acceleration voltage,
wherein the second acceleration voltage is set such that, when the electron beams are radiated onto the insulation film, a difference between the number of electrons entering the insulation film and the number of secondary electrons emitted from the insulation film is smaller at the second acceleration voltage than at the first acceleration voltage.

2. The method of claim 1, wherein a metal other than the metal electrode is formed in the area of the substrate not including the metal electrode.

3. The method of claim 1, wherein the first acceleration voltage and the second acceleration voltage are converted between each other based on stored data of coordinates on the substrate corresponding to the area including the metal electrode and of coordinates on the substrate corresponding to the area not including the metal electrode.

4. A method for inspecting a substrate by radiating electron beams onto a surface of the substrate and detect the number of secondary electrons emitted from the substrate, the substrate having on a surface thereof a patterned area in which a resist mask is formed on an insulation film, and an insulation film area in which the insulation film is exposed outside the resist mask, thus inspecting whether a residue of the resist mask is present on a bottom of a depression formed in the resist mask, the method comprising:
placing the substrate onto a mounting table;
inspecting whether the residue is present on the bottom of the depression formed in the resist mask in such a way as to radiate electron beams onto the patterned area at a first acceleration voltage and detect secondary electrons emitted from the bottom of the depression; and
radiating electron beams onto the insulation film area at a second acceleration voltage,
wherein the second acceleration voltage is set such that, when the electron beams are radiated onto the insulation film, a difference between the number of electrons entering the insulation film and the number of secondary electrons emitted from the insulation film is smaller at the second acceleration voltage than at the first acceleration voltage.

5. The method of claim 4, wherein the first acceleration voltage and the second acceleration voltage are converted between each other based on stored data of coordinates on the substrate corresponding to the patterned area and of coordinates on the substrate corresponding to the insulation film area.

6. The method of claim 1, wherein the second acceleration voltage is set such that, when the electron beams are radiated onto the insulation film, a ratio of the number of secondary electrons emitted from the insulation film to the number of electrons entering the insulation film ranges from 0.8 to 1.2.

7. The method of claim 4, wherein the second acceleration voltage is set such that, when the electron beams are radiated onto the insulation film, a ratio of the number of secondary electrons emitted from the insulation film to the number of electrons entering the insulation film ranges from 0.8 to 1.2.

8. The method of claim 3, wherein the stored data is determined based on pattern information of the substrate.

9. The method of claim 3, wherein a position at which the electron beams are radiated is controlled by moving the mounting table, and the stored data includes information for converting the coordinates on the substrate into coordinates of the mounting table.

10. The method of claim 9, wherein the coordinates on the substrate comprise coordinates on an X-Y coordinate system corresponding to longitudinal and transverse arrangement of integrated circuit chips on the substrate, and
wherein the method further comprises:
imaging an alignment mark on the substrate placed on the mounting table, calculating X-Y coordinate axes based on a result of the imaging of the alignment mark, and determining X-Y coordinate axes of a drive system of the mounting table to be parallel to the respective X-Y coordinate axes calculated based on the result of the imaging of the alignment mark.

11. An apparatus for inspecting a substrate in such a way as to radiate electron beams onto a surface of the substrate including a conductive film and an insulation film that are placed in positional sequence from a bottom to a top and to detect the number of secondary electrons emitted from a surface of a metal electrode embedded in a depression formed in the insulation film so as to inspect whether the metal electrode is electrically connected to the conductive film, the apparatus comprising:
a vacuum container for inspection, having therein a mounting table onto which the substrate is placed;
an emission unit for radiating electron beams onto the substrate;
a detection unit for detecting secondary electrons emitted from the substrate;
an actuator for moving the mounting table in a horizontal direction;
a storage unit for storing information about an acceleration voltage of the electron beams depending on a position of the mounting table with respect to the horizontal direction; and
a control unit for reading the information from the storage unit and output a control signal of the acceleration voltage for radiating the electron beams,
wherein the information of the storage unit is set such that the electron beams are radiated onto an area of the substrate including the metal electrodes at a first acceleration voltage and radiated onto an area of the substrate not including the metal electrodes at a second acceleration voltage, and
the second acceleration voltage is set such that, when the electron beams are radiated onto the insulation film, a difference between the number of electrons entering the insulation film and the number of secondary electrons emitted from the insulation film is smaller at the second acceleration voltage than at the first acceleration voltage.

12. The apparatus of claim 11, wherein a metal other than the metal electrode is formed in the area of the substrate not including the metal electrode.

13. An apparatus for inspecting a substrate in such a way as to radiate electron beams onto a surface of the substrate and detect the number of secondary electrons emitted from the substrate, the substrate having on a surface thereof a patterned area in which a resist mask is formed on an insulation film, and an insulation film area in which the insulation film is exposed outside the resist mask, thus inspecting whether a residue of the resist mask is present on a bottom of a depression formed in the resist mask, the apparatus comprising:
a vacuum container for inspection, having therein a mounting table onto which the substrate is placed;
a emission unit for radiating electron beams onto the substrate;
a detection unit for detecting secondary electrons emitted from the substrate;
an actuator for moving the mounting table in a horizontal direction;
a storage unit for storing information about an acceleration voltage of the electron beams depending on a position of the mounting table with respect to the horizontal direction; and
a control unit for reading the information from the storage unit and output a control signal of the acceleration voltage for radiating the electron beams,
wherein the information of the storage unit is set such that the electron beams are radiated onto the patterned area at a first acceleration voltage and radiated onto the insulation film area at a second acceleration voltage, and
the second acceleration voltage is set such that, when the electron beams are radiated onto the insulation film, a difference between the number of electrons entering the insulation film and the number of secondary electrons emitted from the insulation film is smaller at the second acceleration voltage than at the first acceleration voltage.

14. The apparatus of claim 11, wherein the second acceleration voltage is set such that, when the electron beams are radiated onto the insulation film, a ratio of the number of secondary electrons emitted from the insulation film to the number of electrons entering the insulation film ranges from 0.8 to 1.2.

15. The apparatus of claim 13, wherein the second acceleration voltage is set such that, when the electron beams are radiated onto the insulation film, a ratio of the number of secondary electrons emitted from the insulation film to the number of electrons entering the insulation film ranges from 0.8 to 1.2.

16. The apparatus of claim 11, wherein the information of the storage unit is determined based on pattern information of the substrate.

17. The apparatus of claim 13, wherein the information of the storage unit is determined based on pattern information of the substrate.

18. The apparatus of claim 11, further comprising:
an image capturing unit for imaging an alignment mark on the substrate placed on the mounting table,
wherein coordinates on the substrate comprise coordinates on an X-Y coordinate system corresponding to longitudinal and transverse arrangement of integrated circuit chips on the substrate, and
wherein the control unit calculates X-Y coordinate axes based on the image of the alignment mark imaged by the image capturing unit before the electron beams are radiated onto the substrate, and outputs a control signal such that X-Y coordinate axes of a drive system of the mounting table are determined to be parallel to the respective X-Y coordinate axes calculated based on the image of the alignment mark.

19. The apparatus of claim 13, further comprising:
an image capturing unit for imaging an alignment mark on the substrate placed on the mounting table,
wherein coordinates on the substrate comprise coordinates on an X-Y coordinate system corresponding to longitudinal and transverse arrangement of integrated circuit chips on the substrate, and
wherein the control unit calculates X-Y coordinate axes based on the image of the alignment mark imaged by the image capturing unit before the electron beams are radiated onto the substrate, and outputs a control signal such that X-Y coordinate axes of a drive system of the mounting table are determined to be parallel to the respective X-Y coordinate axes calculated based on the image of the alignment mark.

20. A storage medium that stores a program to be operated in a computer, the program having steps programmed to perform the method of claim 1.
